(19) United States
(12) Patent Application Publication
(10) Pub. No.: US 2023/0054932 A1
(43) Pub. Date: Feb. 23, 2023

(54) NEGATIVE ELECTRODE ACTIVE MATERIAL, NEGATIVE ELECTRODE INCLUDING SAME, SECONDARY BATTERY INCLUDING SAME AND METHOD FOR PREPARING NEGATIVE ELECTRODE ACTIVE MATERIAL

(71) Applicant: LG Energy Solution, LTD., Seoul (KR)

(72) Inventors: Junghyun CHOI, Daejeon (KR); Su Min LEE, Daejeon (KR); Sun Young SHIN, Daejeon (KR); Yong Ju LEE, Daejeon (KR)

(73) Assignee: LG Energy Solution, LTD., Seoul (KR)

(21) Appl. No.: 17/886,142

(22) Filed: Aug. 11, 2022

(30) Foreign Application Priority Data
Aug. 13, 2021 (KR) 10-2021-0107528
Jan. 27, 2022 (KR) 10-2022-0012082

(51) Int. Cl. C01B 33/24

(52) U.S. Cl. CPC C01B 33/24; C01P 2006/40

(57) ABSTRACT

A negative electrode active material, a negative electrode including the same, a secondary battery including the same and a method for preparing a negative electrode active material.

### CROSS-REFERENCE TO RELATED APPLICATIONS

This application claims priority to and the benefit of Korean Patent Application No. 10-2021-0107528 filed in the Korean Intellectual Property Office on Aug. 13, 2021 and Korean Patent Application No. 10-2022-0012082 filed in the Korean Intellectual Property Office on Jan. 27, 2022, the entire contents of which are incorporated herein by reference.

### TECHNICAL FIELD

The present invention relates to a negative electrode active material, a negative electrode including the negative electrode active material, a secondary battery including the negative electrode and a method for preparing the negative electrode active material.

### BACKGROUND ART

Recently, with the rapid spread of electronic appliances using batteries such as mobile phones, notebook-sized computers, and electric vehicles, the demand for small and lightweight secondary batteries having relatively high capacity is rapidly increasing. In particular, lithium secondary batteries are lightweight and have high energy density, and thus have attracted attention as driving power sources for mobile devices. Accordingly, research and development efforts to improve the performance of lithium secondary batteries have been actively conducted.

In general, a lithium secondary battery includes a positive electrode, a negative electrode, a separator interposed between the positive electrode and the negative electrode and an electrolyte. Further, for the positive electrode and the negative electrode, an active material layer each including a positive electrode active material and a negative electrode active material, respectively, may be formed on a current collector. In general, lithium-containing metal oxides such as LiCoO₂ and LiMn₂O₄ have been used as the positive electrode active material for the positive electrode, and lithium-free carbon-containing active materials and silicon-containing active materials have been used as the negative electrode active material for the negative electrode.

Among the negative electrode active materials, the silicon-containing active material is attracting attention because the silicon-containing active material has a high capacity and excellent high-speed charging characteristics compared to the carbon-containing active material. However, the silicon-containing active material has a disadvantage in that the initial efficiency may be low because the degree of volume expansion/contraction due to charging/discharging may be large and the irreversible capacity may be large.

Meanwhile, among silicon-containing active materials, a silicon-containing oxide, specifically, a silicon-containing oxide represented by SiOₓ (0<x<2) has an advantage in that the degree of volume expansion/contraction due to charging/discharging may be low compared to other silicon-containing active materials such as silicon (Si). However, the silicon-containing oxide still has a disadvantage in that the initial efficiency may be lowered depending on the presence of the irreversible capacity.

In this regard, studies have been continuously conducted to reduce irreversible capacity and improve initial efficiency by doping or intercalating a metal, such as Li, Al, and Mg, into silicon-containing oxides. However, in the case of a negative electrode slurry including a metal-doped silicon-containing oxide as a negative electrode active material, there may be a problem in that the metal oxide formed by doping the metal reacts with moisture to increase the pH of the negative electrode slurry and change the viscosity thereof. That is, there may be a problem in that amorphous metal oxides or metal silicates react with moisture to increase the pH of the negative electrode slurry and change the viscosity thereof because the content of an amorphous phase in the negative electrode active material is increased, and accordingly, there may be a problem in that the state of the prepared negative electrode may become poor and the charge/discharge efficiency of the negative electrode may be reduced.

Accordingly, there is a need for the development of a negative electrode active material capable of improving the phase stability of a negative electrode slurry including a silicon-containing oxide and improving the charge/discharge efficiency of a negative electrode prepared therefrom.

Korean Patent No. 10-0794192 relates to a method for preparing a carbon-coated silicon-graphite composite negative electrode active material for a lithium secondary battery and a method for preparing a secondary battery including the same, but has a limitation in solving the above-described problems.

### RELATED ART DOCUMENT

### Patent Document

(Patent Document 1) Korean Patent No. 10-0794192

### SUMMARY OF THE INVENTION

The present invention has been made in an effort to provide a negative electrode active material capable of improving the quality of a negative electrode and improving a charge/discharge efficiency, a negative electrode including the negative electrode active material, a secondary battery including the negative electrode and a method for preparing the negative electrode active material.

An exemplary embodiment of the present invention provides a negative electrode active material including: particles comprising a silicon-containing oxide represented by SiOₓ (0<x<2); and lithium distributed in the particles, in which the lithium is present in the form of (a) crystalline Li₂Si₂O₅, and optionally one or more selected from (b) crystalline Li₂SiO₃, (c) crystalline Li₄SiO₄ or (d) amorphous lithium silicate, a content of the crystalline Li₂Si₂O₅ is higher than the sum of a content of the crystalline Li₂SiO₃ and a content of the crystalline Li₄SiO₄, and a total content of the crystalline phase present in the particles is higher than a total content of the amorphous phase.

Another exemplary embodiment provides a method for preparing the above-described negative electrode active material, the method including: preparing a composition for forming a negative electrode active material by mixing particles including a silicon-containing oxide represented by SiOₓ (0<x<2) with a lithium precursor; and heat-treating the composition for forming the negative electrode active material at a temperature in a range of 780° C. to 900° C.

Still another exemplary embodiment provides a negative electrode including: a negative electrode current collector; and a negative electrode active material layer disposed on at least one surface of the negative electrode current collector, in which the negative electrode active material layer includes a negative electrode material including the above-described negative electrode active material.

Yet another exemplary embodiment provides a secondary battery including: the above-described negative electrode; a positive electrode facing the negative electrode; a separator interposed between the negative electrode and the positive electrode; and an electrolyte.

The negative electrode active material may be a negative electrode active material including particles including a silicon-containing oxide and lithium distributed in the particles, wherein the lithium is present in the form of (a) crystalline Li₂Si₂O₅, and optionally one or more selected from (b) crystalline Li₂SiO₃, (c) crystalline Li₄SiO₄ or (d) amorphous lithium silicate, a content of the crystalline Li₂Si₂O₅ is higher than a sum of a content of the crystalline Li₂SiO₃ and a content of the crystalline Li₄SiO₄, and a total content of the crystalline phase present in the particles is higher than a total content of the amorphous phase. According to the negative electrode active material of the present invention, the content of the crystalline Li₂Si₂O₅ among lithium silicates may be predominantly present, the charge/discharge capacity and efficiency may be high, and gas may not generated during the preparation of the negative electrode slurry, so that it is possible to prepare a stable slurry. Further, according to the negative electrode active material of the present invention, the total content of the crystalline phase is higher than the total content of the amorphous phase, so that since the contents of lithium oxides and lithium silicates reacting with moisture are low, it may be possible to prevent gas generation and viscosity change of the negative electrode slurry and to improve the phase stability of a slurry including the negative electrode active material, so that the qualities of a negative electrode including the negative electrode active material and a secondary battery including the negative electrode can be improved and the charge/discharge efficiency thereof can be improved.

### BRIEF DESCRIPTION OF THE DRAWINGS

The present invention will become more fully understood from the detailed description given below and the accompanying drawings that are given by way of illustration only and thus do not limit the present invention.

FIG. 1 is a flowchart showing a method for preparing a negative electrode active material of the present application.

FIG. 2 is a ²⁹Si-MAS-NMR analysis result of an exemplary negative electrode active material of the present application.

### DETAILED DESCRIPTION

Terms or words used in the specification and the claims should not be interpreted as being limited to typical or dictionary meaning and should be interpreted with a meaning and a concept which conform to the technical spirit of the present invention based on the principle that an inventor can appropriately define a concept of a term in order to describe his/her own invention in the best way.

The terms used in the present specification are used only to describe specific embodiments, and are not intended to limit the present invention. Singular expressions include plural expressions unless the context clearly indicates otherwise.

In the present invention, the term “comprise”, “include”, or “have” is intended to indicate the presence of the characteristic, number, step, constituent element, or any combination thereof implemented, and should be understood to mean that the presence or addition possibility of one or more other characteristics or numbers, steps, constituent elements, or any combination thereof is not precluded.

In the present specification, an average particle diameter (D₅₀) may be defined as a particle diameter corresponding to 50% of a cumulative volume in a particle size distribution curve (graph curve of the particle size distribution map) of the particles. The average particle diameter (D₅₀) may be measured using, for example, a laser diffraction method. The laser diffraction method can generally measure a particle size of about several mm to the submicron region, and results with high reproducibility and high resolution may be obtained.

<Negative Electrode Active Material>

Hereinafter, a negative electrode active material will be described in detail.

The present invention relates to a negative electrode active material, and more specifically, to a negative electrode active material for a lithium secondary battery.

Specifically, the negative electrode active material according to the present invention is a negative electrode active material including: particles including a silicon-containing oxide represented by SiOₓ (0<x<2); and lithium distributed in the particles, wherein the lithium is present in the form of (a) crystalline Li₂Si₂O₅, and optionally one or more selected from (b) crystalline Li₂SiO₃, (c) crystalline Li₄SiO₄ or (d) amorphous lithium silicate, a content of the crystalline Li₂Si₂O₅ is higher than the sum of a content of the crystalline Li₂SiO₃ and a content of the crystalline Li₄SiO₄, and a total content of the crystalline phase present in the particles is higher than a total content of the amorphous phase.

In a negative electrode active material including a silicon-containing oxide in the related art, studies have been conducted to remove the irreversible capacity of the silicon-containing oxide or increase the initial efficiency by doping or distributing lithium or the like to the negative electrode active material. However, since the contents of crystalline Li₂SiO₃ and crystalline Li₄SiO₄ are high and the content of the amorphous phase is high in such a negative electrode active material, there is a problem in that during the preparation of a negative electrode slurry, specifically, an aqueous negative electrode slurry, reactions of moisture with lithium oxides and/or lithium silicates increase gas generation, increase the pH of the negative electrode slurry, and reduce the phase stability, so that there is a problem in that the quality of a prepared negative electrode is poor and the charge/discharge efficiency is reduced.

To solve these problems, the negative electrode active material according to the present invention may be a negative electrode active material including: particles including a silicon-containing oxide represented by SiOₓ (0<x<2); and lithium distributed in the particles, wherein the lithium is present in the form of (a) crystalline Li₂Si₂O₅, and optionally one or more selected from (b) crystalline Li₂SiO₃, (c) crystalline Li₄SiO₄ or (d) amorphous lithium silicate, a content of the crystalline Li₂Si₂O₅ is higher than the sum of a content of the crystalline Li₂SiO₃ and a content of the crystalline Li₄SiO₄, and a total content of the crystalline phase present in the particles is higher than a total content of the amorphous phase.

For the negative electrode active material of the present invention, since the content of the crystalline Li₂Si₂O₅ among lithium silicates may be predominantly present, the charge/discharge capacity and efficiency are high, and gas is not generated during the preparation of the negative electrode slurry, so that it is possible to prepare a stable slurry.

For the negative electrode active material of the present invention, the total content of the crystalline phase is higher than the total content of the amorphous phase, so that since the contents of lithium oxides and lithium silicates reacting with moisture are low, it may be possible to prevent the gas generation and viscosity change of the negative electrode slurry and to improve the phase stability of a slurry including the negative electrode active material, so that the qualities of a negative electrode including the negative electrode active material and a secondary battery including the negative electrode can be improved and the charge/discharge efficiency thereof can be improved.

The negative electrode active material according to an exemplary embodiment of the present invention includes: particles including a silicon-containing oxide represented by SiOₓ (0<x<2); and lithium distributed in the particles.

In an exemplary embodiment of the present invention, the particles of negative electrode active material include a silicon-containing oxide represented by SiOₓ (0<x<2). Since SiO₂ does not react with lithium ions, and thus cannot store lithium, it is preferred that x is within the above range of 0<x<2. Specifically, the silicon-containing oxide may be a compound represented by SiOₓ (0.5≤x≤1.5) in terms of structural stability of the active material. The SiOₓ (0<x<2) may correspond to a matrix in the particles of negative electrode active material.

In an exemplary embodiment of the present invention, the particles of the negative electrode active material may have an average particle diameter (D₅₀) of 0.1 μm to 20 μm, preferably 1 μm to 15 μm, and more preferably 2 μm to 10 μm. When the D₅₀ of the particles satisfies the above range of 0.1 μm to 20 μm, the active material during charging and discharging may be ensured to be structurally stable, and it may be possible to prevent a problem in that the volume expansion/contraction level also becomes large as the particle diameter is excessively increased, and to prevent a problem in that the initial efficiency is reduced because the particle diameter is excessively small.

In an exemplary embodiment of the present invention, the particles of the negative electrode active material may be included in an amount of 75 parts by weight to 99 parts by weight, preferably 80 parts by weight to 97 parts by weight, and more preferably 87 parts by weight to 96 parts by weight based on total 100 parts by weight of the negative electrode active material. In another exemplary embodiment, the particles of the negative electrode active material may be included in an amount of 91 to 92 parts by weight based on total 100 parts by weight of the negative electrode active material. When the particles are within the above range of 75 parts by weight to 99 parts by weight, lithium may be included in the negative electrode active material at an appropriate level, so that it is preferred in terms of the fact that both the charge/discharge capacity and efficiency of the negative electrode can be improved.

In an exemplary embodiment of the present invention, the lithium may be distributed in the particles of the negative electrode active material. The lithium may be distributed in the particles, and thus removes the irreversible capacity of the silicon-containing oxide, and may contribute to the improvement of the initial efficiency and charge/discharge efficiency of the negative electrode active material.

Specifically, the lithium may be distributed on the surface, inside or on the surface and inside of the particles of the negative electrode active material. Furthermore, the particles may be doped with the lithium. As examples, in the case of in-situ doping of lithium, the lithium may tend to be uniformly distributed over the surface and inside, and in the case of ex-situ doping, the lithium concentration may tend to be higher in the vicinity of the particle surface as compared to inside the particle.

In an exemplary embodiment of the present invention, the lithium may be included in an amount of 0.5 part by weight to 25 parts by weight, preferably 1 part by weight to 15 parts by weight based on total 100 parts by weight of the negative electrode active material. In another exemplary embodiment, the lithium may be included in an amount of 4 to 10 parts by weight based on total 100 parts by weight of the negative electrode active material. Within the above range of 0.5 part by weight to 25 parts by weight, it is preferred because an effect of improving the initial efficiency and charge/discharge efficiency of the negative electrode active material may be improved.

In an exemplary embodiment of the present invention, the lithium may be distributed in the form of lithium silicate in the particles of negative electrode active material, and accordingly, it is possible to play a role capable of improving the initial efficiency and charge/discharge efficiency of the negative electrode active material by removing the irreversible capacity of the particles. In this case, silicate means a compound including silicon, oxygen and one or more metals.

Specifically, the lithium may be distributed on the surface, inside or on the surface and inside of the particles of the negative electrode active material in a form of lithium silicate. The lithium silicate may correspond to a matrix in the particles of negative electrode active material.

Specifically, the lithium may be present in the form of at least (a) crystalline Li₂Si₂O₅, and optionally one or more selected from (b) crystalline Li₂SiO₃, (c) crystalline Li₄SiO₄ or (d) amorphous lithium silicate, and a content of the crystalline Li₂Si₂O₅ is higher than the sum of a content of the crystalline Li₂SiO₃ and a content of the crystalline Li₄SiO₄.

In an exemplary embodiment of the present invention, the negative active material comprises crystalline lithium silicate, and the crystalline lithium silicate comprises crystalline Li₂Si₂O₅ and crystalline Li₂SiO₃. Specifically, the lithium is present in a form of (a) crystalline Li₂Si₂O₅, (b) crystalline Li₂SiO₃, and optionally one or more selected from (c) crystalline Li₄SiO₄ or (d) amorphous lithium silicate.

The crystalline Li₂Si₂O₅ may be stable in the negative electrode active material, and particularly causes fewer side reactions with moisture in a negative electrode slurry, specifically an aqueous negative electrode slurry. Therefore, a negative electrode slurry including a negative electrode active material including the crystalline Li₂Si₂O₅, particularly an aqueous negative electrode slurry generates less gas due to reactions with moisture, prevents the pH increase of the negative electrode slurry, and improves the phase stability of the slurry, and the quality of a negative electrode prepared from the negative electrode slurry may be improved, and the charge/discharge efficiency may be improved.

In contrast, in the case of the crystalline Li₂SiO₃ and the crystalline Li₄SiO₄, there may be a problem of causing side reactions with moisture in the negative electrode slurry, which makes gas generation serious, and there may occur a problem in that by-products such as Li₂O formed by side reactions with moisture increase the pH of the negative electrode slurry, destabilize the phase of the slurry, and change the viscosity.

In this regard, since a content of the crystalline Li₂Si₂O₅ may be higher than a content of the crystalline Li₂SiO₃ and a content of the crystalline Li₄SiO₄ in the negative electrode active material of the present invention, the initial efficiency and charge/discharge efficiency may be improved by smoothly removing the irreversible capacity of the negative electrode active material, and by improving the phase stability of a negative electrode slurry including the negative electrode active material and preventing the problem in that the viscosity is lowered, the quality of the negative electrode may be improved, the charge/discharge capacity may be expressed at an excellent level, and the charge/discharge efficiency may be improved. Further, as described below, since the negative electrode active material of the present invention reduces the total content of the amorphous phase along with the enhancement of the content of the crystalline Li₂Si₂O₅, it is possible to improve the phase stability of the above-described negative electrode slurry, prevent the negative electrode from malfunctioning, and significantly improve the charge/discharge capacity and efficiency.

In an exemplary embodiment of the present invention, the crystalline Li₂Si₂O₅ may be included in an amount of 1 part by weight to 63 parts by weight, 3 parts by weight to 60 parts by weight, 4 to 50 parts by weight or 5 parts by weight to 45 parts by weight, more preferably 20 to 40 parts by weight based on total 100 parts by weight of the particles of the negative electrode active material. When the content of the crystalline Li₂Si₂O₅ satisfies the above range of 1 part by weight to 63 parts by weight, it is preferred in terms of the fact that when a negative electrode slurry, particularly, an aqueous negative electrode slurry is prepared, the generation of side reactions of moisture with the negative electrode active material can be reduced, the phase stability of the negative electrode slurry can be further improved, and the charge/discharge capacity can be stably implemented because the electrode state is good.

In an exemplary embodiment of the present invention, the crystalline Li₂SiO₃ may be included in an amount of 40 parts by weight or less, specifically 35 parts by weight or less, based on total 100 parts by weight of the particles of the negative electrode active material. In another exemplary embodiment, the crystalline Li₂SiO₃ may be included in an amount of 30 parts by weight or less, 25 parts by weight or less, or 20 parts by weight or less based on total 100 parts by weight of the particles. The lower limit of the content of the crystalline Li₂SiO₃ may be 0.1 part by weight, 1 part by weight, 1.5 parts by weight or 2 parts by weight.

In an exemplary embodiment of the present invention, the crystalline Li₄SiO₄ may be included in an amount of 5 parts by weight or less, specifically 3 parts by weight or less based on total 100 parts by weight of the particles of the negative electrode active material, and more specifically, the crystalline Li₄SiO₄ may not be present in the negative electrode active material. When the content of the crystalline Li₄SiO₄ satisfies the above range of 5 parts by weight or less, it is preferred in terms of the fact that during the preparation of a negative electrode slurry, specifically, an aqueous negative electrode slurry, the generation of by-products such as Li₂O caused by reactions of moisture with the negative electrode active material, an increase in pH of the negative electrode slurry caused by the generation of by-products, and a deterioration in quality of the negative electrode are prevented.

In an exemplary embodiment of the present invention, the difference between the content of the crystalline Li₂Si₂O₅ and the content of the crystalline Li₂SiO₃ may be 1 part by weight to 40 parts by weight, 5 parts by weight to 40 parts by weight, 8 to 40 parts by weight, specifically 10 parts by weight to 35 parts by weight, and more specifically 10 parts by weight to 30 parts by weight, based on total 100 parts by weight of the particles. Within the above range of 1 part by weight to 40 parts by weight, it is possible to improve the phase stability of the above-described negative electrode slurry, prevent the negative electrode from malfunctioning, and significantly improve the charge/discharge capacity and efficiency.

Confirmation and content measurement of the crystalline lithium silicate of the crystalline Li₂SiO₃, crystalline Li₄SiO₄ or crystalline Li₂Si₂O₅ may be performed by an analysis through an X-ray diffraction profile by X-ray diffraction analysis or ²⁹Si-magic angle spinning-nuclear magnetic resonance (²⁹Si-MAS-NMR).

Among them, ²⁹Si-MAS-NMR analysis is a type of solid phase NMR techniques, and is an NMR analysis performed by rapidly spinning a rotor containing a sample at a magic angle B_{M} (for example, 54.74°) with respect to the magnetic field B₀. Through this, it is possible to measure the presence/absence, content, and the like of the crystalline Li₂SiO₃, the crystalline Li₄SiO₄, the crystalline Li₂Si₂O₅, the crystalline Si, the crystalline SiO₂, the amorphous phase, and the like included in the negative electrode active material of the present invention.

In an exemplary embodiment of the present invention, during the ²⁹Si-MAS-NMR analysis of the negative electrode active material, the height of a peak p1 of Li₂SiO₃ that appears at a chemical shift peak of −70 ppm to −80 ppm may be smaller than the height of a peak p2 of Li₂Si₂O₅ that appears at a chemical shift peak of −90 ppm to −100 ppm.

In an exemplary embodiment of the present invention, during the ²⁹Si-MAS-NMR analysis of the negative electrode active material, the ratio p2/p1 of the height of a peak p2 of Li₂Si₂O₅ that appears at a chemical shift peak of −90 ppm to −100 ppm with respect to the height of a peak p1 of Li₂SiO₃ that appears at a chemical shift peak of −70 ppm to −80 ppm may be more than 0.1 and 6.5 or less, more than 1 and 6.5 or less, or 1.5 or more and 5 or less, specifically 2 or more and 4 or less. Within the above range of more than 0.1 and 6.5 or less, the crystalline Li₂Si₂O₅ is sufficiently present in the negative electrode active material, so that gas generation caused by side reactions of moisture with the negative electrode active material may be reduced, an increase in pH due to by-products caused by side reactions with moisture may be prevented, the phase stability of the slurry may be improved, the quality of a negative electrode prepared from the negative electrode slurry may be improved, and the charge/discharge efficiency may be improved.

In an exemplary embodiment of the present invention, a peak p3 of Li₄SiO₄ that appears at a chemical shift peak of −60 ppm to −69 ppm may not be present during the ²⁹Si-MAS-NMR analysis of the negative electrode active material. In this case, it is preferred in terms of the fact that generation of by-products such as Li₂O caused by side reactions of moisture with Li₄SiO₄ in the negative electrode active material, an increase in pH of the negative electrode slurry caused by the generation of by-products, and a deterioration in quality of the negative electrode are prevented.

The contents of the crystalline Li₂SiO₃, crystalline Li₄SiO₄, and crystalline Li₂Si₂O₅ may be implemented by performing a heat treatment process, adjusting the heat treatment temperature, performing an acid treatment process, and the like in a method for preparing a negative electrode active material to be described below, but are not limited thereto.

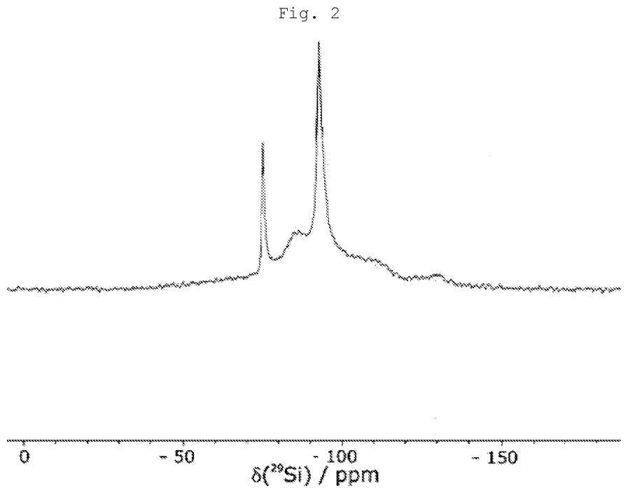

FIG. 2 shows a ²⁹Si-MAS-NMR analysis result of an negative electrode active material according to an exemplary embodiment of the present invention. Specifically, in the ²⁹Si-MAS-NMR analysis of the negative electrode active material according to an exemplary embodiment of the present invention, the height of the peak p1 of Li₂SiO₃ appearing at −70 ppm to −80 ppm may be smaller than the height of the peak p2 of Li₂Si₂O₅ appearing at −90 ppm to −100 ppm.

In an exemplary embodiment of the present invention, the negative electrode active material may include crystalline SiO₂ in an amount of less than 5 parts by weight, specifically less than 4 parts by weight, and 3 parts by weight or less in still another exemplary embodiment, based on total 100 parts by weight of the particles. Preferably, the negative electrode active material includes crystalline SiO₂ in an amount of 1 part by weight or less, based on total 100 parts by weight of the particles, but may not include crystalline SiO₂ at all. When the content of the crystalline SiO₂ satisfies the above range of less than 5 parts by weight, the negative electrode is readily charged and discharged, so that the charge/discharge capacity and efficiency may be excellently improved.

In an exemplary embodiment of the present invention, the negative electrode active material may include crystalline Si in an amount of 10 parts by weight to 50 parts by weight, 20 parts by weight to 40 parts by weight or 26 parts by weight to 35 parts by weight based on total 100 parts by weight of the particles. When the content of the crystalline Si satisfies the above range of 10 parts by weight to 50 parts by weight, the negative electrode is readily charged and discharged, so that the charge/discharge capacity and efficiency may be excellently improved.

In an exemplary embodiment of the present invention, the total content of the crystalline phase present in the particles is higher than the total content of the amorphous phase. The total content of the crystalline phase means the total content of all the crystalline phases including crystalline Si, crystalline SiO₂, crystalline Li₂SiO₃, crystalline Li₄SiO₄, crystalline Li₂Si₂O₅, and the like, which are present in the particles, and the total content of the amorphous phase may mean the content except for the total content of the crystalline phase present in the particles. That is, the total content of the amorphous phase comprises the amorphous SiO₂ or the like in addition to the amorphous lithium silicate, and means the sum of the contents of the total amorphous phase present in the particles.

Since the total content of the crystalline phase present in the particles is higher than the total content of the amorphous phase in the negative electrode active material of the present invention, the content of amorphous lithium silicate and the like, which are highly reactive with moisture, is reduced during the preparation of a negative electrode slurry, specifically an aqueous negative electrode slurry, so that it is preferred in terms of the fact that the generation of by-products such as Li₂O caused by side reactions with moisture, an increase in pH of the negative electrode slurry caused by the generation of by-products, and a deterioration in quality of the negative electrode are prevented.

In an exemplary embodiment of the present invention, the total content of the crystalline phase present in the particles may be more than 50 parts by weight and 80 parts by weight or less, or more than 50 parts by weight and 75 parts by weight or less, or 55 parts by weight or more and 75 parts by weight or less, or 60 parts by weight or more and 70 parts by weight or less, or 64 parts by weight or more and 68 parts by weight or less, or 64 parts by weight or more and 66 parts by weight or less, based on total 100 parts by weight of the particles.

In an exemplary embodiment of the present invention, the total content of the amorphous phase present in the particles may be 20 parts by weight to 50 parts by weight, or 25 parts by weight to 50 parts by weight, or 25 parts by weight to 45 parts by weight, or 30 parts by weight to 40 parts by weight, or 32 parts by weight to 36 parts by weight, or 34 parts by weight to 36 parts by weight, based on total 100 parts by weight of the particles.

In an exemplary embodiment of the present invention, the difference between the total content of the crystalline phase and the total content of the amorphous phase present in the particles may be 10 parts by weight to 60 parts by weight, 20 parts by weight to 50 parts by weight, 25 parts by weight to 40 parts by weight, or 28 parts by weight to 36 parts by weight, or 30 parts by weight to 36 parts by weight, based on total 100 parts by weight of the particles.

In an exemplary embodiment of the present invention, the ratio of the total weight of the crystalline phase relative to the total weight of the amorphous phase present in the particles (the total weight of the crystalline phase:the total weight of the amorphous phase) may be 55:45 to 75:25, or 60:40 to 70:30.

When the contents of the crystalline phase and amorphous phase present in the particles satisfy the above range, the contents of the crystalline phase and amorphous phase present in the negative electrode active material are appropriately adjusted, so that during the preparation of a negative electrode slurry (specifically, an aqueous negative electrode slurry), the content of amorphous lithium silicate, and the like, which are highly reactive with moisture, is reduced, so that the generation of by-products such as Li₂O caused by side reactions with moisture, an increase in pH of the negative electrode slurry caused by the generation of by-products, and a change in viscosity may be prevented, and it is preferred in terms of the fact that the content of crystalline SiO₂, which hinders the expression of the charge/discharge capacity and efficiency, is not excessively increased.

Although the content of crystalline Li₂Si₂O₅ may be the highest among lithium silicates, when the total content of the crystalline phase present in the negative electrode active material does not satisfy the above range, the crystalline phase is excessively included in the negative electrode active material, so that there is a problem in that it is difficult to implement capacity/efficiency and the service life characteristics also deteriorate because the battery is not readily charged and discharged.

The total contents of the crystalline phase and the amorphous phase, which are present in the particles may be measured by a quantitative analysis method using an X-ray diffraction analysis (XRD).

The negative electrode active material of the present invention may further include a carbon layer disposed on the respective particles. The carbon layer may function as a protective layer that suppresses the volume expansion of the particles and prevents side reactions with an electrolytic solution.

In an exemplary embodiment of the present invention, the carbon layer may be included in an amount of 0.1 part by weight to 10 parts by weight, preferably 1 part by weight to 7 parts by weight, and more preferably 3 to 5 parts by weight based on total 100 parts by weight of the negative electrode active material. When the content of the carbon layer satisfies the above range of 0.1 part by weight to 10 parts by weight, it is preferred in terms of the fact that the carbon layer can prevent side reactions with an electrolytic solution while controlling the volume expansion of the particles at an excellent level.

In an exemplary embodiment of the present invention, the carbon layer may include at least one of amorphous carbon and crystalline carbon.

In an exemplary embodiment of the present invention, the carbon layer may be an amorphous carbon layer. Specifically, the carbon layer may be formed by a chemical vapor deposition (CVD) method using at least one hydrocarbon gas selected from the group consisting of methane, ethane and acetylene.

In an exemplary embodiment of the present invention, when the negative electrode active material is acid-treated, lithium by-products selected from the group consisting of crystalline lithium silicates, Li₂O, LiOH and Li₂CO₃ may be scarcely present or may not be present on the surface of the negative electrode active material. The lithium by-products increase the pH of the negative electrode slurry, lower the viscosity thereof, and thus may cause the electrode state of the negative electrode to be poor. Accordingly, an effect of improving the quality and charge/discharge efficiency of the negative electrode may be implemented at a preferred level by performing an acid treatment process of the negative electrode active material to remove lithium silicates and by-products such as Li₂O present on the surface of the negative electrode active material.

In an exemplary embodiment of the present invention, a negative electrode active material obtained by adding 0.5 g of the negative electrode active material to 50 mL of distilled water and stirring the resulting mixture for 3 hours may have a pH of 9 or more and 13 or less, or 9 or more and 12 or less, 9.5 or more and 11.5 or less, or 10 or more and 11 or less, or 10 or more and 10.5 or less at 23° C. When the pH of the resulting product satisfies the above range of 9 or more and 13 or less, it is possible to evaluate that the content of the material which causes side reactions between the negative electrode active material and moisture, lowers the viscosity by increasing the pH of the negative electrode slurry, and reduces the phase stability is reduced to a preferred level. Therefore, when the pH of the resulting product satisfies the above range of 9 or more and 13 or less, for the negative electrode active material, the increase in pH caused by by-products due to side reactions with moisture may be prevented at a preferred level, the phase stability of the slurry may be improved, the quality of a negative electrode prepared from the negative electrode slurry may be improved, and the charge/discharge efficiency may be improved.

In an exemplary embodiment of the present invention, the negative electrode active material may have an average particle diameter (D₅₀) of 0.1 μm to 20 μm, preferably 1 μm to 15 μm, and more preferably 2 μm to 10 μm. When the D₅₀ of the negative electrode active material satisfies the above range of 0.1 μm to 20 μm, the structural stability of the active material during charging and discharging is ensured, and it is possible to prevent a problem in that the volume expansion/contraction level also becomes large as the particle diameter is excessively increased, and to prevent a problem in that the initial efficiency is reduced because the particle diameter is excessively small.

In an exemplary embodiment of the present invention, during the measurement of the X-ray diffraction of the negative electrode active material using CuK_{α} ray, when the height of a peak of Li₂Si₂O₅ whose diffraction angle 2θ is present in a range of 24.4° to 25.0° and the height of a peak of Li₂SiO₃ whose diffraction angle 2θ is present in a range of 18.6° to 19.2° are defined as g1 and g2, respectively, g2/g1 may be >0.05, and specifically, g2/g1 may be >0.1 or g2/g1 may be >0.2.

When the g2/g1 is equal to or less than the above range (e.g., equal to or less than 0.05), there is a problem in that the amount of Li₂SiO₃ stable for charge/discharge is excessively decreased, and as a result, the service life performance may be inferior.

The X-ray diffraction of the negative electrode active material may be measured using X'Pert Pro. manufactured by PANalytical Ltd. Specifically, based on a moving average approximation curve obtained using a data specific number of 11 for a diffraction intensity value in which the diffraction angle 2θ is at an interval of 0.02°, it is possible to measure the peak height g1 of Li₂Si₂O₅ whose diffraction angle 2θ appears in the range of 24.4° to 25.0° and the peak height g2 of Li₂SiO₃ whose diffraction angle 2θ appears in the range of 18.6° to 19.2°.

<Preparation Method of Negative Electrode Active Material>

The present invention provides a method for preparing a negative electrode active material, specifically a method for preparing the above-described negative electrode active material.

Specifically, the method for preparing a negative electrode active material includes: preparing a composition for forming a negative electrode active material by mixing particles including a silicon-containing oxide represented by SiOₓ (0<x<2) with a lithium precursor; and heat-treating the composition for forming a negative electrode active material at a temperature in a range of 780° C. to 900° C.

By the method for preparing a negative electrode active material of the present invention, it is possible to prepare the above-described negative electrode in which the content of the crystalline Li₂Si₂O₅ is higher than the sum of the contents of the crystalline Li₂SiO₃ and the crystalline Li₄SiO₄, and the total content of the crystalline phase present in the particles is higher than the total content of the amorphous phase. Accordingly, for a negative electrode active material prepared from the method for preparing a negative electrode active material of the present invention, since the content of crystalline Li₂Si₂O₅ among lithium silicates may be predominantly present, the charge/discharge capacity and efficiency are high, gas generation caused by side reactions with moisture may be suppressed, and the total content of the crystalline phase is higher than the total content of the amorphous phase, so that during the preparation of a negative electrode slurry (specifically, an aqueous negative electrode slurry), the content of amorphous lithium silicate, and the like, which are highly reactive with moisture, is reduced, so that the generation of by-products such as Li₂O caused by side reactions with moisture, an increase in pH of the negative electrode slurry caused by the generation of by-products, and a change in viscosity may be prevented, the quality of a negative electrode including the negative electrode active material and a secondary battery including the negative electrode is improved, and the charge/discharge efficiency may be improved.

The method for preparing a negative electrode active material of the present invention includes: preparing a composition for forming a negative electrode active material by mixing particles including a silicon-containing oxide represented by SiOₓ (0<x<2) with a lithium precursor.

In an exemplary embodiment of the present invention, the particles include a silicon-containing oxide represented by SiOₓ (0<x<2). Since SiO₂ does not react with lithium ions, and thus cannot store lithium, it is preferred that x is within the above range of 0<x<2. Specifically, the silicon-containing oxide may be a compound represented by SiOₓ (0.5≤x≤1.5) in terms of structural stability of the active material.

In an exemplary embodiment of the present invention, the average particle diameter (D₅₀) of the particles may be 0.1 μm to 20 μm, preferably 1 μm to 15 μm, and more preferably 2 μm to 10 μm in terms of the fact that the active material during charging and discharging is ensured to be structurally stable, a problem in that the as the particle diameter is excessively increased, volume expansion/contraction level is also increased is prevented, and a problem in that due to the excessively small particle diameter, the initial efficiency is reduced is prevented.

In an exemplary embodiment of the present invention, the lithium precursor enables lithium to be distributed in the particles by a heat treatment process to be described below. Specifically, the lithium precursor may include at least one selected from the group consisting of lithium metal, LiOH, LiH, and Li₂CO₃, and specifically, may include lithium metal in terms of the fact that when the particles and the lithium precursor are reacted, an additional oxidation is prevented. The lithium precursor may be in the form of particle, and specifically, may be lithium metal powder.

In an exemplary embodiment of the present invention, the lithium precursor may include stabilized lithium metal powder (SLMP).

In an exemplary embodiment of the present invention, the particles and the lithium precursor may be solid-phase mixed. Specifically, during the mixing, the particles and the lithium precursor are in a solid state, and in this case, during the formation of a negative electrode active material by a heat treatment to be described below, the void ratio and the specific surface area in the negative electrode active material may be controlled at appropriate levels, so that the volume expansion of the negative electrode active material according to charging and discharging may be preferably controlled.

In an exemplary embodiment of the present invention, the particles and the lithium precursor may be mixed while being heat-treated under an inert gas atmosphere. Specifically, the particles and the lithium precursor may be mixed while being heat-treated at a temperature in a range of 100° C. to 300° C., specifically, 150° C. to 200° C. When the lithium precursor and the particles are mixed while being heat-treated under the aforementioned conditions, the lithium precursor and the particles are more uniformly mixed, and the reaction occurs in advance under mild conditions, so that lithium may be uniformly distributed in the particles.

The method for preparing a negative electrode active material of the present invention includes heat-treating the composition for forming a negative electrode active material at a temperature in a range of 780° C. to 900° C.

By a heat treatment process in the above temperature range, lithium may be distributed in the particles, and specifically, lithium may be distributed on the surface, inside or on the surface and inside of the particles.

By a heat treatment process in the above temperature range, the above-described negative electrode active material can be prepared. Specifically, the lithium may be distributed in the form of lithium silicate in the particles by a heat treatment process in the above temperature range, and accordingly, it is possible to play a role capable of improving the initial efficiency and charge/discharge efficiency of the negative electrode active material by removing the irreversible capacity of the particles. Specifically, the lithium may be present in the form of (a) crystalline Li₂Si₂O₅, and optionally one or more selected from (b) crystalline Li₂SiO₃, (c) crystalline Li₄SiO₄ or (d) amorphous lithium silicate. In this case, in the negative electrode active material prepared from the method for preparing a negative electrode active material of the present invention, a content of the crystalline Li₂Si₂O₅ may be higher than the sum of a content of the crystalline Li₂SiO₃ and a content of the crystalline Li₄SiO₄.

The total content of the crystalline phase present in the particles may be higher than the total content of the amorphous phase by a heat treatment process in the above temperature range, and accordingly, since the contents of lithium oxides and lithium silicates reacting with moisture are low, it is possible to prevent gas generation and viscosity change of the negative electrode slurry and to improve the phase stability of a slurry including the negative electrode active material, so that the qualities of a negative electrode including the negative electrode active material and a secondary battery including the negative electrode can be improved and the charge/discharge efficiency thereof can be improved.

If the heat treatment process is performed at a temperature less than 780° C., the content of the amorphous phase of a negative electrode active material prepared by the preparation method is increased and the content of crystalline Li₂Si₂O₅ is decreased, so that the phase stability of a negative electrode slurry deteriorates, the generation of side reactions with moisture in the negative electrode slurry (specifically, an aqueous negative electrode slurry) may be severe, and accordingly, there may occur a problem in that the electrode state of the negative electrode including the negative electrode active material becomes poor and the charge/discharge efficiency is reduced. If the heat treatment process is performed at a temperature more than 900° C., the content of crystalline SiO₂ is increased and crystalline SiO₂ acts as a resistor during charging and discharging, so that there may occur a problem in that charging and discharging is not facilitated and the charge/discharge capacity and efficiency deteriorate, which is not preferred.

Specifically, the heat treatment may be performed at 780° C. to 890° C. or 800° C. to 870° C., and when the temperature is within the above range, it is preferred in terms of the fact that the crystalline lithium silicate of Li₂Si₂O₅ is easily developed.

The heat treatment may be performed for a time of 1 hour to 12 hours, specifically 2 hours to 8 hours. When the time is within the above range of 1 hour to 12 hours, the lithium silicate may be uniformly distributed in the particles, so that the above-described charge/discharge efficiency improving effect may be further improved.

The heat treatment may be performed in an inert atmosphere in terms of the fact that an additional oxidation of the particles and the lithium precursor may be prevented. Specifically, the heat treatment may be performed in an inert atmosphere by at least one gas selected from the group consisting of nitrogen gas, argon gas, and helium gas.

The method for preparing a negative electrode active material of the present invention may further include performing an acid treatment on the heat-treated composition for forming a negative electrode active material. Lithium silicates such as crystalline Li₂SiO₃ and crystalline Li₄SiO₄ and by-products such as Li₂O present on the surface of the negative electrode active material by the heat treatment process may cause the electrode state of the negative electrode to be poor by increasing the pH of a negative electrode slurry including the negative electrode active material and lowering the viscosity thereof. Accordingly, it is possible to implement an effect of improving the quality and charge/discharge efficiency of the negative electrode at a preferred level by performing an acid treatment process after the heat treatment process to remove lithium silicates such as crystalline Li₂SiO₃ and crystalline Li₄SiO₄ and by-products such as Li₂O present on the surface of the negative electrode active material.

Specifically, the acid treatment may be performed by treating the heat-treated composition for forming a negative electrode active material with an aqueous acid solution including at least one acid selected from the group consisting of hydrochloric acid (HCl), sulfuric acid (H₂SO₄), nitric acid (HNO₃) and phosphoric acid (H₃PO₄), specifically, at least one acid selected from the group consisting of hydrochloric acid (HCl), sulfuric acid (H₂SO₄), and nitric acid (HNO₃) for 0.3 hour to 6 hours, specifically, 0.5 hour to 4 hours, and is preferred in terms of the fact that by-products present on the surface of the negative electrode active material can be readily removed by the process.

The pH of the aqueous acid solution at 23° C. may be 3 or less, specifically 2 or less, and more specifically a pH of 1, in terms of the fact that by-products present on the surface of the negative electrode active material can be readily removed.

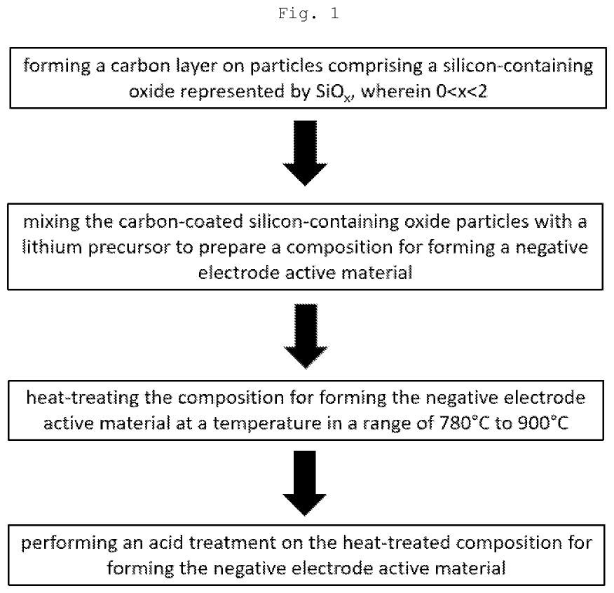

An exemplary process for preparing a negative electrode active material of the present invention is set forth in FIG. 1.

The method for preparing a negative electrode active material of the present invention may further include forming a carbon layer on respective particles including the silicon-containing oxide before mixing the particles including the silicon-containing oxide with a lithium precursor. The carbon layer may be disposed or formed on the particles, and thus may function as a protective layer capable of appropriately controlling volume expansion according to charging and discharging of the negative electrode active material and preventing side reactions with an electrolytic solution. Meanwhile, a process of forming the carbon layer may be performed before the process of mixing the particles with the lithium precursor in terms of the fact that changes in crystalline phase and amorphous phase of the negative electrode active material are prevented.

The forming of the carbon layer may be performed by a chemical vapor deposition (CVD) method, and specifically, may be performed by a chemical vapor deposition (CVD) method using at least one hydrocarbon gas selected from the group consisting of methane, ethane and acetylene. More specifically, the forming of the carbon layer may be performed by providing at least one hydrocarbon gas selected from the group consisting of methane, ethane and acetylene to the acid-treated composition for forming a negative electrode active material, and then heat-treating the composition by a chemical vapor deposition (CVD) method. By the method, a carbon layer may be formed on silicon-containing oxide particles at a uniform level, so that the volume expansion of the particles may be smoothly controlled and side reactions caused by an electrolytic solution may be prevented.

The forming of the carbon layer may be performed at a temperature in a range of 800° C. to 1,100° C., preferably 850° C. to 1,000° C., in terms of the fact that changes in crystalline phase and amorphous phase in the negative electrode active material prepared in the above step are prevented.

The description on other carbon layers may be the same as that described above.

<Negative Electrode>

The present invention provides a negative electrode, specifically, a negative electrode for a lithium secondary battery.

In an exemplary embodiment of the present invention, the negative electrode includes the above-described negative electrode active material.

The negative electrode according to the present invention includes: a negative electrode current collector; and a negative electrode active material layer disposed on at least one surface of the negative electrode current collector, and the negative electrode active material layer includes a negative electrode material. The negative electrode material includes the above-described negative electrode active material.

The negative electrode current collector is not particularly limited as long as it has high conductivity without causing a chemical change in the battery. Specifically, the negative electrode current collector may include at least one selected from the group consisting of copper, stainless steel, aluminum, nickel, titanium, sintered carbon, and an aluminum-cadmium alloy, and specifically, copper.

The negative electrode current collector may have a thickness of typically 3 μm to 500 μm.

The negative electrode current collector may also strengthen the binding force of the negative electrode active material by forming fine irregularities on the surface thereof. For example, the negative electrode current collector may be used in various forms such as a film, a sheet, a foil, a net, a porous body, a foam, and a non-woven fabric body.

The negative electrode active material layer is disposed on at least one surface of the negative electrode current collector. Specifically, the negative electrode active material layer may be disposed on one surface or both surfaces of the negative electrode current collector.

In an exemplary embodiment of the present invention, the negative electrode material may be included in an amount of 60 parts by weight to 99 parts by weight, specifically 70 parts by weight to 98 parts by weight, based on total 100 parts by weight of the negative electrode active material layer.

The negative electrode material may further include a carbon-containing active material along with the above-described negative electrode active material.

The carbon-containing active material may include at least one selected from the group consisting of artificial graphite, natural graphite, hard carbon, soft carbon, carbon black, graphene and fibrous carbon, and preferably, may include at least one selected from the group consisting of artificial graphite and natural graphite.

The negative electrode material may include the above-described negative electrode active material and carbon-containing active material at a weight ratio of 1:99 to 60:40, preferably at a weight ratio of 3:97 to 50:50.

The negative electrode active material layer may include a binder.

The binder may include at least one selected from the group consisting of styrene butadiene rubber (SBR), acrylonitrile butadiene rubber, acrylic rubber, butyl rubber, fluoro rubber, polyvinyl alcohol, carboxymethyl cellulose (CMC), starch, hydroxypropyl cellulose, regenerated cellulose, polyvinyl alcohol (PVA), polyacrylic acid (PAA), polyethylene glycol (PEG), polyacrylonitrile (PAN), and polyacryl amide (PAM), in terms of further improving the electrode adhesion force and imparting sufficient resistance to the volume expansion/contraction of an active material. Preferably, it is preferred that the binder includes styrene butadiene rubber and carboxymethyl cellulose in terms of the fact that it is possible to prevent the distortion, bending, and the like of the electrode by having high strength, having excellent resistance to the volume expansion/contraction of the negative electrode active material, and imparting excellent flexibility to the binder.

In an exemplary embodiment of the present invention, the binder may be included in an amount of 0.5 part by weight to 30 parts by weight, specifically 1 part by weight to 20 parts by weight based on total 100 parts by weight of the negative electrode active material layer, and within the above range, it is preferred in terms of the fact that the volume expansion of the active material can be more effectively controlled.

The negative electrode active material layer may include a conductive material. The conductive material can be used to improve the conductivity of the negative electrode, and may have conductivity without inducing a chemical change. Specifically, the conductive material may include at least one selected from the group consisting of natural graphite, artificial graphite, carbon black, acetylene black, Ketjen black, channel black, furnace black, lamp black, thermal black, conductive fiber, carbon nanotube (CNT), fluoro carbon, aluminum powder, nickel powder, zinc oxide, potassium titanate, titanium oxide and polyphenylene derivatives, preferably, may include at least one selected from carbon black and carbon nanotube in terms of implementing high conductivity, and more preferably, may include carbon black and carbon nanotube.

In an exemplary embodiment of the present invention, the conductive material may be included in an amount of 0.5 part by weight to 25 parts by weight, specifically 1 part by weight to 20 parts by weight, based on total 100 parts by weight of the negative electrode active material layer.

In an exemplary embodiment of the present invention, the negative electrode active material layer may have 30 μm to 100 μm, preferably 40 μm to 80 μm in terms of the fact that the electrical contact with components in the negative electrode active material layer is enhanced.

<Negative Electrode Slurry>

The present invention provides a negative electrode slurry including a negative electrode material.

In an exemplary embodiment of the present invention, the negative electrode material includes the above-described negative electrode active material.

In an exemplary embodiment of the present invention, the negative electrode slurry may include the negative electrode material, the binder and the conductive material.

In an exemplary embodiment of the present invention, the negative electrode material may be included in the negative electrode slurry in an amount of 60 parts by weight to 99 parts by weight, specifically 70 parts by weight to 98 parts by weight, based on total 100 parts by weight of the solid content of the negative electrode slurry.

In an exemplary embodiment of the present invention, the binder may be included in the negative electrode slurry in an amount of 0.5 part by weight to 30 parts by weight, specifically 1 part by weight to 20 parts by weight, based on total 100 parts by weight of the solid content of the negative electrode slurry.

In an exemplary embodiment of the present invention, the conductive material may be included in the negative electrode slurry in an amount of 0.5 part by weight to 25 parts by weight, specifically 1 part by weight to 20 parts by weight, based on total 100 parts by weight of the solid content of the negative electrode slurry.

The description on the negative electrode material, the binder, and the conductive material is the same as that described above.

The negative electrode slurry according to an exemplary embodiment of the present invention may further include a solvent for forming a negative electrode slurry. Specifically, the solvent for forming a negative electrode slurry may include at least one selected from the group consisting of distilled water, ethanol, methanol, and isopropyl alcohol, specifically distilled water in terms of facilitating the dispersion of the components.

In an exemplary embodiment of the present invention, the solid content weight of the negative electrode slurry may be 20 parts by weight to 75 parts by weight, specifically 30 parts by weight to 70 parts by weight, based on total 100 parts by weight of the negative electrode slurry.

In an exemplary embodiment of the present invention, the negative electrode slurry may have a viscosity of 500 cP to 20,000 cP, specifically 1,000 cP to 10,000 cP, at 23° C.

When the viscosity is within the above range of 500 cP to 20,000 cP, the coating property of the negative electrode slurry is improved, so that it is possible to implement a negative electrode having an excellent quality condition. In this case, the viscosity may be measured at 23° C. using a viscometer (device name: Brookfield viscometer, manufacturer: Brookfield).

In the present invention, the negative electrode slurry may have a pH of 6 to 12.5, specifically 6.5 to 12.25, or specifically 7 to 12 at 23° C.

When the pH of the negative electrode slurry satisfies the above range of 6 to 12.5, the content of the material which causes side reactions between the negative electrode active material and moisture, lowers the viscosity by increasing the pH of the negative electrode slurry, and reduces the phase stability may be reduced to a preferred level. Therefore, when the pH of the negative electrode slurry at 23° C. satisfies the above range of 6 to 12.5, for the negative electrode active material, the increase in pH caused by by-products due to side reactions with moisture may be prevented at a preferred level, the phase stability of the slurry may be improved, the quality of a negative electrode prepared from the negative electrode slurry may be improved, and the charge/discharge efficiency may be improved.

The negative electrode may be prepared by a method including: preparing a negative electrode slurry including a negative electrode material including the above-described negative electrode active material; applying the negative electrode slurry onto a negative electrode current collector; and drying and roll-pressing the applied negative electrode slurry.

The negative electrode slurry may further include an additional negative electrode active material.

As the additional negative electrode active material, a compound capable of reversible intercalation and deintercalation of lithium may be used. Specific examples thereof include a carbonaceous material such as artificial graphite, natural graphite, graphitized carbon fiber, and amorphous carbon; a metallic compound alloyable with lithium such as Si, Al, Sn, Pb, Zn, Bi, In, Mg, Ga, Cd, a Si alloy, a Sn alloy, or an Al alloy; a metal oxide which may be undoped and doped with lithium such as SiO_{β} (0<β<2), SnO₂, vanadium oxide, lithium titanium oxide, and lithium vanadium oxide; or a composite including the metallic compound and the carbonaceous material such as a Si—C composite or a Sn—C composite, and the like, and any one thereof or a mixture of two or more thereof may be used. Furthermore, a metallic lithium thin film may be used as the negative electrode active material. Alternatively, both low crystalline carbon and high crystalline carbon, and the like may be used as the carbon material. Typical examples of the low crystalline carbon include soft carbon and hard carbon, and typical examples of the high crystalline carbon include irregular, planar, flaky, spherical, or fibrous natural graphite or artificial graphite, Kish graphite, pyrolytic carbon, mesophase pitch-based carbon fibers, meso-carbon microbeads, mesophase pitches, and high-temperature sintered carbon such as petroleum or coal tar pitch derived cokes.

The additional negative electrode active material may be a carbon-containing negative electrode active material.

In an exemplary embodiment of the present invention, a weight ratio of the negative electrode active material and the additional negative electrode active material included in the negative electrode slurry may be 10:90 to 90:10, specifically 10:90 to 50:50.

<Secondary Battery>

The present invention provides a secondary battery including the above-described negative electrode, specifically, a lithium secondary battery.

Specifically, the secondary battery according to the present invention includes: the above-described negative electrode; a positive electrode facing the negative electrode; a separator interposed between the negative electrode and the positive electrode; and an electrolyte.

The positive electrode may include a positive electrode current collector; a positive electrode active material layer formed on the positive electrode current collector.

The positive electrode current collector is not particularly limited as long as it has high conductivity without causing a chemical change in the battery. Specifically, as the positive electrode current collector, it is possible to use copper, stainless steel, aluminum, nickel, titanium, sintered carbon, a material in which the surface of copper or stainless steel is surface-treated with carbon, nickel, titanium, silver, and the like, an aluminum-cadmium alloy, and the like.

The positive electrode current collector may have a thickness of typically 3 μm to 500 μm.

The positive electrode current collector may also strengthen the binding force of the positive electrode active material by forming fine irregularities on the surface thereof. For example, the positive electrode current collector may be used in various forms such as a film, a sheet, a foil, a net, a porous body, a foam, and a non-woven fabric body.

The positive electrode active material layer may include a positive electrode active material.

The positive electrode active material is a compound capable of reversible intercalation and deintercalation of lithium, and specifically, may include a lithium transition metal composite oxide including at least one transition metal consisting of nickel, cobalt, manganese and aluminum, and lithium, preferably a lithium transition metal composite oxide including a transition metal including nickel, cobalt and manganese, and lithium.

More specifically, examples of the lithium transition metal composite oxide include a lithium-manganese-based oxide (for example, LiMnO₂, LiMn₂O₄, and the like), a lithium-cobalt-based oxide (for example, LiCoO₂, and the like), a lithium-nickel-based oxide (for example, LiNiO₂, and the like), a lithium-nickel-manganese-based oxide (for example, LiNi_{1-Y}Mn_{Y}O₂ (here, 0<Y<1), LiMn_{2-z}Ni_{z}O₄ (here, 0<Z<2), and the like), a lithium-nickel-cobalt-based oxide (for example, LiNi_{1-Y1}Co_{Y1}O₂ (here, 0<Y1<1) and the like), a lithium-manganese-cobalt-based oxide (for example, LiCo_{1-Y2}Mn_{Y2}O₂ (here, 0<Y2<1), LiMn_{2-z1}Co_{z1}O₄ (here, 0<Z1<2), and the like), a lithium-nickel-manganese-cobalt-based oxide (for example, Li(NiₚCo_{q}Mnᵣ₁)O₂ (here, 0<p<1, 0<q<1, 0<r1<1, p+q+r1=1) or Li(Niₚ₁Co_{q1}Mnᵣ₂)O₄ (here, 0<p1<2, 0<q1<2, 0<r2<2, p1+q1+r2=2), and the like), or a lithium-nickel-cobalt-transition metal (M) oxide (for example, Li(Niₚ₂Co_{q2}Mnᵣ₃Mₛ₂)O₂ (here, M is selected from the group consisting of Al, Fe, V, Cr, Ti, Ta, Mg, and Mo, p2, q2, r3, and s2 are each an atomic fraction of independent elements, and 0<p2<1, 0<q2<1, 0<r3<1, 0<s2<1, and p2+q2+r3+s2=1), and the like), and the like, and among them, any one or two or more compounds may be included. Among them, in view of enhancing the capacity characteristics and stability of a battery, the lithium transition metal composite oxide may be LiCoO₂, LiMnO₂, LiNiO₂, a lithium nickel-manganese-cobalt oxide (for example, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, or the like), a lithium nickel cobalt aluminum oxide (for example, Li(Ni_{0.8}Co_{0.15}Al_{0.05})O₂, and the like), and the like, and in consideration of remarkable improvement effects caused by controlling the type and content ratio of constituent elements forming a lithium transition metal composite oxide, the lithium transition metal composite oxide may be Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, and the like, and among them, any one or a mixture of two or more may be used.

The positive electrode active material may be included in an amount of 80 wt % to 99 wt %, preferably 92 wt % to 98 wt % in a positive electrode active material layer in consideration of exhibiting a sufficient capacity of the positive electrode active material, and the like.

The positive electrode active material layer may further include a binder and/or a conductive material together with the above-described positive electrode active material.

The binder is a component which assists in the cohesion of an active material, a conductive material, and the like and the cohesion of a current collector, and specifically, may include at least one selected from the group consisting of polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), a sulfonated EPDM, styrene-butadiene rubber, and fluorine rubber, preferably polyvinylidene fluoride.

The binder may be included in an amount of 1 wt % to 20 wt, preferably 1.2 wt % to 10 wt % in the positive electrode active material layer, in terms of sufficiently securing a cohesive force between components such as a positive electrode active material.

The conductive material can be used to assist and improve the conductivity of the secondary battery, and is not particularly limited as long as the conductive material has conductivity without causing a chemical change. Specifically, the conductive material may include at least one selected from the group consisting of graphite such as natural graphite or artificial graphite; carbon black such as carbon black, acetylene black, Ketjen black, channel black, furnace black, lamp black, and thermal black; conductive fiber such as carbon fiber and metallic fiber; conductive tubes such as carbon nanotubes; metallic powder such as fluoro carbon, aluminum, and nickel powder; conductive whiskers such as zinc oxide and potassium titanate; conductive metal oxide such as titanium oxide; and polyphenylene derivatives, and preferably, the conductive material may include carbon black in terms of the fact of improving conductivity.

The conductive material may be included in an amount of 1 wt % to 20 wt %, preferably 1.2 wt % to 10 wt % in the positive electrode active material layer, in terms of sufficiently securing the electric conductivity.

The positive electrode active material layer may have a thickness of 30 μm to 400 μm, preferably 50 μm to 110 μm.

The positive electrode may be manufactured by coating the positive electrode current collector with a positive electrode slurry including a positive electrode active material and selectively a binder, a conductive material and a solvent for forming a positive electrode slurry, and then drying and rolling.

The solvent for forming a positive electrode slurry may include an organic solvent such as N-methyl-2-pyrrolidone (NMP), and may be used in an amount to obtain a preferred viscosity when including the positive electrode active material, and selectively, a binder, a conductive material, and the like. For example, the solvent for forming a positive electrode slurry may be included in the positive electrode slurry, such that the concentration of a solid including a positive electrode active material and selectively a binder and a conductive material is 50 wt % to 95 wt %, preferably 70 wt % to 90 wt %.

The separator separates the negative electrode and the positive electrode and provides a passage for movement of lithium ions, and can be used without particular limitation as long as the separator is typically used as a separator in a lithium secondary battery, and in particular, it is preferred that the separator has low resistance to the ionic movement of an electrolyte and has an excellent electrolyte solution impregnation ability. Specifically, it is possible to use a porous polymer film, for example, a porous polymer film formed of a polyolefin-based polymer such as an ethylene homopolymer, a propylene homopolymer, an ethylene/butene copolymer, an ethylene/hexene copolymer, and an ethylene/methacrylate copolymer, or a laminated structure of two or more layers thereof. In addition, a typical porous non-woven fabric, for example, a non-woven fabric made of a glass fiber having a high melting point, a polyethylene terephthalate fiber, and the like may also be used. Furthermore, a coated separator including a ceramic component or a polymeric material may be used to secure heat resistance or mechanical strength and may be selectively used as a single-layered or multi-layered structure.

Examples of the electrolyte used in the present invention include an organic liquid electrolyte, an inorganic liquid electrolyte, a solid polymer electrolyte, a gel-type polymer electrolyte, a solid inorganic electrolyte, a molten-type inorganic electrolyte, and the like, which can be used in the preparation of a secondary battery, but are not limited thereto.

Specifically, the electrolyte may include an organic solvent and a lithium salt.

The organic solvent is not particularly limited as long as the organic solvent can act as a medium through which ions involved in the electrochemical reaction of the battery can move. Specifically, as the organic solvent, it is possible to use an ester-based solvent such as methyl acetate, ethyl acetate, gamma-butyrolactone, and ε-caprolactone; an ether-based solvent such as dibutyl ether or tetrahydrofuran; a ketone-based solvent such as cyclohexanone; an aromatic hydrocarbon-containing solvent such as benzene and fluorobenzene; a carbonate-based solvent such as dimethyl carbonate (DMC), diethyl carbonate (DEC), ethyl methyl carbonate (EMC), ethylene carbonate (EC), and propylene carbonate (PC); an alcohol-based solvent such as ethyl alcohol and isopropyl alcohol; nitriles such as R-CN (R is a C2 to C20 linear, branched or cyclic structured hydrocarbon group, and may include a double bond aromatic ring or an ether bond); amides such as dimethylformamide; dioxolanes such as 1,3-dioxolane; or sulfolanes, and the like. Among them, a carbonate-based solvent is preferred, and a mixture of a cyclic carbonate having high ionic conductivity and a high dielectric constant (for example, ethylene carbonate, propylene carbonate, or the like) capable of enhancing the charging and discharging performance of the battery and a linear carbonate-based compound having low viscosity (for example, ethyl methyl carbonate, dimethyl carbonate, diethyl carbonate, or the like) is more preferred. In this case, the performance of the electrolyte solution may be excellent when a cyclic carbonate and a chain carbonate are mixed and used at a volume ratio of about 1:1 to about 1:9.

The lithium salt is not particularly limited as long as the lithium salt is a compound capable of providing lithium ions used in a lithium secondary battery. Specifically, as the lithium salt, it is possible to use LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, LiB(C₂O₄)₂, and the like. It is desirable to use the lithium salt within a concentration range of 0.1 M to 2.0 M. When the concentration of the lithium salt is included within the above range of 0.1 M to 2.0 M, the electrolyte has appropriate conductivity and viscosity, so that excellent electrolyte performance may be exhibited, and lithium ions may move effectively.

The secondary battery may be prepared by interposing a separator between the above-described negative electrode and positive electrode, and then injecting an electrolyte thereinto by a typical method for preparing a secondary battery.

The secondary battery according to the present invention is useful for the fields of portable devices such as mobile phones, notebook-sized computers, and digital cameras and electric vehicles such as hybrid electric vehicles (HEVs), and may be preferably used as particularly, a constituent battery of a medium-sized and large-sized battery module. Therefore, the present invention also provides a medium-sized and large-sized battery module including the aforementioned secondary battery as a unit battery.

Such medium-sized and large-sized battery modules may be preferably applied to power sources which require high output and large capacity, such as electric vehicles, hybrid electric vehicles, and electric power storage devices.

Hereinafter, the Examples of the present invention will be described in detail such that a person skilled in the art to which the present invention pertains can easily carry out the present invention. However, the present invention can be implemented in various different forms, and is not limited to the Examples described herein.

### Example 1

(1) Preparation of Negative Electrode Active Material

As a silicon-containing oxide particle, SiOₓ (0.5≤x≤1.5) was prepared (average particle diameter (D₅₀): 6 μm). Silicon-containing oxide particles on which a carbon layer was formed by chemical vapor deposition (CVD) of methane as a hydrocarbon gas on the silicon-containing oxide particles at 950° C. were prepared.

A composition for forming a negative electrode active material was prepared by solid-phase mixing of the silicon-containing oxide particles on which the carbon layer was formed and lithium metal powder as a lithium precursor at a weight ratio of 93:7.

The composition for forming a negative electrode active material was heat-treated at 850° C. for 3 hours.

The heat-treated composition for forming a negative electrode active material was treated with an aqueous hydrochloric acid solution having a pH of 1 at 23° C. for 1 hour.

A material obtained by the acid treatment was used as a negative electrode active material of Example 1. In the negative electrode active material, a weight ratio of the silicon-containing oxide particles:lithium (Li):the carbon layer was 91.3:4.7:4.0.

(2) Preparation of Negative Electrode Slurry

A negative electrode material, a binder and a conductive material were added at a weight ratio of 95:3:2 to distilled water as a solvent for forming a negative electrode slurry and mixed to prepare a negative electrode slurry (solid content is 50 wt % with respect to the total weight of the negative electrode slurry).

The negative electrode material is obtained by mixing the above-described negative electrode active material and artificial graphite as a carbon-containing active material at a weight ratio of 20:80. Further, the binder is obtained by mixing carboxymethyl cellulose and styrene-butadiene rubber at a weight ratio of 50:50, and the conductive material is obtained by mixing carbon black and carbon nanotube at a weight ratio of 75:25.

(3) Preparation of Negative Electrode

One surface of a copper current collector (thickness: 20 μm) as a negative electrode current collector was coated with the negative electrode slurry in a loading amount of 180 mg/25 cm², and the copper current collector was roll-pressed and dried in a vacuum oven at 130° C. for 8 hours to form a negative electrode active material layer (thickness: 50 μm), which was employed as a negative electrode (thickness of the negative electrode: 70 μm).

(4) Preparation of Secondary Battery

As a positive electrode, a lithium metal counter electrode was used.

A polyethylene separator was interposed between the negative electrode and the positive electrode, which were prepared above, and an electrolyte was injected thereinto to prepare a secondary battery.

The electrolyte was obtained by adding 0.5 wt % of vinylene carbonate based on the total weight of the electrolyte to an organic solvent in which ethylene carbonate (EC) and ethylmethyl carbonate (EMC) were mixed at a volume ratio of 30:70 and adding LiPF₆ as a lithium salt at a concentration of 1 M thereto.

### Example 2

A negative electrode active material, a negative electrode slurry, a negative electrode and a secondary battery were prepared in the same manner as in Example 1, except that the heat treatment was performed at 790° C. in the preparation of the negative electrode active material.

### Example 3

A negative electrode active material, a negative electrode slurry, a negative electrode and a secondary battery were prepared in the same manner as in Example 1, except that the heat treatment was performed at 890° C. in the preparation of the negative electrode active material.

### Example 4

A negative electrode active material, a negative electrode slurry, a negative electrode and a secondary battery were prepared in the same manner as in Example 1, except that the acid treatment process was not performed in the preparation of the negative electrode active material.

### Example 5

A negative electrode active material, a negative electrode slurry, a negative electrode and a secondary battery were prepared in the same manner as in Example 1, except that the heat treatment was performed at 890° C. in the preparation of the negative electrode active material and the heat-treated composition for forming a negative electrode active material was treated with an aqueous hydrochloric acid solution having a pH of 1 at 23° C. for 30 minutes.

### Example 6

A negative electrode active material, a negative electrode slurry, a negative electrode and a secondary battery were prepared in the same manner as in Example 1, except that the heat treatment was performed at 790° C. in the preparation of the negative electrode active material and the heat-treated composition for forming a negative electrode active material was treated with an aqueous hydrochloric acid solution having a pH of 1 at 23° C. for 2 hours.

### Comparative Example 1

A negative electrode active material, a negative electrode slurry, a negative electrode and a secondary battery were prepared in the same manner as in Example 1, except that a heat treatment was performed at 770° C. in the preparation of the negative electrode active material.

### Comparative Example 2

A negative electrode active material, a negative electrode slurry, a negative electrode and a secondary battery were prepared in the same manner as in Example 1, except that the heat treatment was performed at 770° C. and the acid treatment process was not performed in the preparation of the negative electrode active material.

### Comparative Example 3

A negative electrode active material, a negative electrode slurry, a negative electrode and a secondary battery were prepared in the same manner as in Example 1, except that the heat treatment was performed at 1,000° C. in the preparation of the negative electrode active material.

### Comparative Example 4

A negative electrode active material, a negative electrode slurry, a negative electrode and a secondary battery were prepared in the same manner as in Example 1, except that the heat treatment was performed at 1,000° C. and the acid treatment process was not performed in the preparation of the negative electrode active material.

### Comparative Example 5

A negative electrode active material, a negative electrode slurry, a negative electrode and a secondary battery were prepared in the same manner as in Comparative Example 1, except that the acid treatment was performed for 4 hours.

The constitutions of the negative electrode active materials prepared in Examples 1 to 6 and Comparative Examples 1 to 5 were measured by the following methods, and are shown in Tables 1 and 2.

<Measurement of p2/p1 and p3/p1>

In Table 2, p2/p1 and p3/p1 were calculated by ²⁹Si MAS NMR analysis as follows.

(1) p2/p1: ratio of the height (p2) of the peak of Li₂Si₂O₅ to the height (p1) of the peak of Li₂SiO₃ during ²⁹Si MAS NMR analysis

(2) p3/p1: ratio of the height (p3) of the peak of Li₄SiO₄ to the height (p1) of the peak of Li₂SiO₃ during ²⁹Si MAS NMR analysis

<Measurement of Total Content of Crystalline Li₂Si₂O₅, Crystalline Li₂SiO₃, Crystalline Li₄SiO₄, Crystalline SiO₂, Crystalline Si, and Crystalline Phase and Total Content of Amorphous Phase>

Measurement was made using an Xray diffraction (XRD) device (trade name: D4-endavor, manufacturer: Bruker). For the type and wavelength of a light source, an X-ray wavelength generated by CuKα was used, and the wavelength (λ) of the light source was 0.15406 nm. After a reference material MgO and the negative electrode active material were mixed at a weight ratio of 20:80, the resulting mixture was put into a cylindrical holder with a diameter of 2.5 cm and a height of 2.5 mm, and flattening work was performed using a slide glass such that the height of a sample in the holder was constant to prepare a sample for XRD analysis. SCANTIME was set to 1 hour and 15 minutes, a measurement region was set to a region where 2θ was 10° to 90°, and STEP TIME and STEP SIZE were set so as to scan 2θ by 0.02° per second. The measurement results were analyzed for X-ray diffraction profiles by Rietveld refinement using an X-ray diffraction pattern analysis software. The total content of crystalline Li₂Si₂O₅, crystalline Li₂SiO₃, crystalline Li₄SiO₄, crystalline SiO₂, crystalline Si, and the crystalline phase and the total content of the amorphous phase were measured by the analysis.

<Measurement of pH Parameters of Negative Electrode Active Material>

After 0.5 g of the negative electrode active material of each of the Examples and Comparative Examples obtained above was added to 50 mL of distilled water and the resulting mixture was stirred for 3 hours, the pH of the resulting product obtained by filtering at 23° C. was measured.

TABLE 1

| | Based on 100 parts by weight of negative electrode active material | | | | |
|---|---|---|---|---|---|
| | | | | Heat | |
| | | | Carbon layer | treatment | Presence or |
| | SiOₓ content | Li content | content | temperature | absence of acid |
| | (parts by weight) | (parts by weight) | (parts by weight) | (° C.) | treatment process |
| Example 1 | 91.3 | 4.7 | 4.0 | 850 | ○ |
| Example 2 | 91.7 | 4.3 | 4.0 | 790 | ○ |
| Example 3 | 91.2 | 4.8 | 4.0 | 890 | ○ |
| Example 4 | 89.0 | 7.0 | 4.0 | 850 | X |
| Example 5 | 90.0 | 6.0 | 4.0 | 890 | ○ |
| Example 6 | 92.5 | 3.5 | 4.0 | 790 | ○ |
| Comparative | 92.0 | 4.0 | 4.0 | 770 | ○ |
| Example 1 | | | | | |
| Comparative | 89.0 | 7.0 | 4.0 | 770 | X |
| Example 2 | | | | | |
| Comparative | 91.3 | 4.7 | 4.0 | 1,000 | ○ |
| Example 3 | | | | | |
| Comparative | 89.0 | 7.0 | 4.0 | 1,000 | X |
| Example 4 | | | | | |
| Comparative | 94.0 | 2.0 | 4.0 | 770 | ○ |
| Example 5 | | | | | |

TABLE 2
Based on total 100 parts by weight of silicon-containing oxide particles (Li-SiOx)

| | | | | | | | | Total | Total | |
|---|---|---|---|---|---|---|---|---|---|---|
| | crystalline | | crystalline | crystalline | | crystalline | crystalline | content | content | |
| | Li₂Si₂O₅ | | Li₂SiO₃ | Li₄SiO₄ | | SiO₂ | Si | (parts by | (parts by | |
| | Content | | Content | Content | | Content | Content | weight) of | weight) of | |
| | (parts by | | (parts by | (parts by | | (parts by | (parts by | crystalline | amorphous | pH |
| | weight) | p2/p1 | weight) | weight) | p3/p1 | weight) | weight) | phase | phase | parameter |
| Example 1 | 25 | 2.5 | 10 | 0 | 0 | 0 | 30 | 65 | 35 | 10 |
| Example 2 | 22 | 2 | 12 | 0 | 0 | 0 | 30 | 64 | 36 | 10.5 |
| Example 3 | 28 | 3 | 2 | 0 | 0 | 3 | 33 | 66 | 34 | 10.5 |
| Example 4 | 25 | 2.3 | 15 | 1 | 0. 03 | 0 | 27 | 68 | 32 | 13 |
| Example 5 | 28 | 2.7 | 5 | 0 | 0 | 3 | 35 | 71 | 29 | 12 |
| Example 6 | 22 | 2 | 2 | 0 | 0 | 0 | 30 | 54 | 46 | 9.5 |
| Comparative | 8 | 0.7 | 13 | 0 | 0 | 0 | 25 | 46 | 54 | 13 |
| Example 1 | | | | | | | | | | |
| Comparative | 5 | 0.4 | 16 | 1 | 0. 06 | 0 | 22 | 46 | 54 | 13.5 |
| Example 2 | | | | | | | | | | |
| Comparative | 25 | 1 | 25 | 1 | 0. 07 | 5 | 25 | 81 | 19 | 12.5 |
| Example 3 | | | | | | | | | | |
| Comparative | 27 | 0. 9 | 30 | 2 | 0. 1 | 5 | 25 | 89 | 11 | 13 |
| Example 4 | | | | | | | | | | |
| Comparative | 8 | 1.5 | 5 | 0 | 0 | 0 | 25 | 38 | 62 | 11 |
| Example 5 | | | | | | | | | | |

### Experimental Example 1: Evaluation of Phase Stability of Negative Electrode Slurry

<Experiment of Evaluating pH of Negative Electrode Slurry>

The pH of the negative electrode slurry of each of the Examples and Comparative Examples prepared above at 23° C. was measured, and is shown in the following Table 3.

<Experiment of Evaluating Viscosity of Negative Electrode Slurry>

Immediately after the negative electrode slurry of each of the Examples and the Comparative Examples was prepared, the viscosity at 23° C. was measured using a viscometer (trade name: Brookfield viscometer, manufacturer: Brookfield). Further, after the negative electrode slurry of each of the Examples and the Comparative Examples prepared above was stored for 3 days, the viscosity of the negative electrode slurry at 23° C. was measured.

<Measurement of Amount of Gas Generated from Negative Electrode Slurry>

The negative electrode slurry of each of the Examples and Comparative Examples prepared above was put into an aluminum pouch having a volume of 7 mL and sealed.

A difference between the weight of the aluminum pouch containing the negative electrode slurry in the air and the weight of the aluminum pouch containing the negative electrode slurry in water at 23° C. was determined, and a volume of gas immediately after preparing the negative electrode slurry was measured by dividing the difference by the density of water at 23° C.

Next, after the aluminum pouch containing the negative electrode slurry was stored at 60° C. for 3 days, a difference between the weight of the aluminum pouch containing the negative electrode slurry in the air and the weight of the aluminum pouch containing the negative electrode slurry in water at 23° C. was determined, and a volume of gas after storing the negative electrode slurry for 3 days was measured by dividing the difference by the density of water at 23° C.

A difference between the volume of gas measured after storing the negative electrode slurry for 3 days and the volume of gas measured immediately after preparing the negative electrode slurry was defined as an amount of gas generated, and is shown in the following Table 3.

TABLE 3

| | | Viscosity (cP, @ 23° C.) | | | |
|---|---|---|---|---|---|
| | | Immediately after | After negative | | Amount |
| | pH | negative electrode | electrode slurry is | Difference | (mL) of |
| | (@ 23° C.) | slurry is prepared (a) | stored for 3 days (b) | (a − b) | gas generated |
| Example 1 | 10 | 3,300 | 3,000 | 300 | 10 |
| Example 2 | 10.5 | 3,500 | 3,300 | 200 | 10 |
| Example 3 | 10.5 | 3,400 | 3,100 | 300 | 10 |
| Example 4 | 13 | 1,000 | 500 | 500 | 15 |
| Example 5 | 12 | 3,000 | 2,650 | 350 | 12 |
| Example 6 | 9.5 | 3,700 | 3,350 | 350 | 12 |
| Comparative | 13 | 2,700 | 2,200 | 500 | 25 |
| Example 1 | | | | | |
| Comparative | 13.5 | 1,000 | 500 | 500 | 35 |
| Example 2 | | | | | |
| Comparative | 12.5 | 2,000 | 1,600 | 400 | 30 |
| Example 3 | | | | | |
| Comparative | 13 | 2,000 | 1,500 | 500 | 30 |
| Example 4 | | | | | |
| Comparative | 11 | 3,000 | 2,500 | 500 | 20 |
| Example 5 | | | | | |

Examples 1 to 3, 5 and 6 are characterized in that the content of crystalline Li₂Si₂O₅ is high and the total content of the crystalline phase present in the negative electrode active material is higher than the total content of the amorphous phase. From the configuration, it can be confirmed that Examples 1 to 3, 5 and 6 exhibit high viscosity due to the low pH of the negative slurry, have excellent phase stability due to a low change in viscosity of the slurry, and do not generate gas due to few side reactions. In Examples 1 to 3, it can be seen that the total crystalline phase content in the negative active material is appropriate than in Examples 5 and 6, and thus, less gas is generated during slurry formation.

It can be confirmed that Example 4 has a higher slurry pH than those of Examples 1 to 3 because the acid treatment process is not performed, but has a larger amount of gas generated than those of Examples 1 to 3, 5 and 6 due to less occurrence of side reactions with moisture in the aqueous negative electrode slurry because the content of crystalline Li₂Si₂O₅ is higher than the sum of the content of crystalline Li₂SiO₃ and the content of crystalline Li₄SiO₄, but still has a smaller amount of gas generated than those of Comparative Examples 1 to 4.

In contrast, it can be confirmed that in the case of Comparative Examples 1 to 4, low viscosity is exhibited due to the high pH of the negative electrode slurry, and side reactions easily occur because the change in viscosity of the slurry is significant, and as a result, gas is generated and the phase stability deteriorates.

It could be confirmed that in the case of Comparative Example 5, the pH was low due to the low total content of lithium, but the reactivity in the slurry was significant due to the high content of the amorphous phase in the negative electrode active material, and as a result, the change in viscosity of the slurry was significant and gas was generated.

### Experimental Example 2: Evaluation of Charge/Discharge Efficiency of Secondary Battery

The discharge capacity, initial efficiency, and capacity retention rate were evaluated by charging and discharging the batteries of Examples 1 to 6 and Comparative Examples 1 to 5, and are shown in the following Table 4.

Meanwhile, for the 1st and 2nd cycles, the battery was charged and discharged at 0.1 C, and from the 3rd cycle to the 50th cycle, the battery was charged and discharged at 0.5 C.

Charging conditions: CC (constant current)/CV (constant voltage) (5 mV/0.005 C current cut-off)

Discharging conditions: CC (constant current) conditions 1.5 V

The discharge capacity (mAh/g) and initial efficiency (%) were derived from the results during one-time charge/discharge. Specifically, the initial efficiency (%) was derived by the following calculation.

Initial efficiency (%)=(discharge capacity after 1 time discharge/1 time charge capacity)×100

The charge retention rate was derived by the following calculation.

Capacity retention rate (%)=(50 times discharge capacity/1 time discharge capacity)×100

[Table 4]

| | Discharge | Initial | Capacity |
|---|---|---|---|
| | capacity | efficiency | retention rate |
| | (mAh/g) | (%) | (%) |
| Example 1 | 550 | 89 | 85 |
| Example 2 | 545 | 88 | 84 |
| Example 3 | 545 | 88 | 84 |
| Example 4 | 545 | 88 | 84 |
| Example 5 | 544 | 88 | 83 |
| Example 6 | 544 | 88 | 84 |
| Comparative | 540 | 87 | 80 |
| Example 1 | | | |
| Comparative | 530 | 85 | 75 |
| Example 2 | | | |
| Comparative | 535 | 87 | 78 |
| Example 3 | | | |
| Comparative | 525 | 86 | 76 |
| Example 4 | | | |
| Comparative | 543 | 82 | 83 |
| Example 5 | | | |

In Table 4, it can be confirmed that in Examples 1 to 6 in which the negative electrode active material according to the present invention is used, the content of crystalline Li₂Si₂O₅ is high, the total content of the crystalline phase present in the negative electrode active material is higher than the total content of the amorphous phase, and as a result, the increase in pH of the negative electrode slurry is prevented, the phase stability of the slurry is improved, the quality of a negative electrode prepared from the negative electrode slurry is improved due to less occurrence of gas caused by reactions with moisture in the negative electrode slurry, and the discharge capacity, initial efficiency and capacity retention rate are excellent due to the improvement in charge/discharge efficiency.

In contrast, it can be confirmed that in Comparative Examples 1 to 5, side reactions with moisture in the negative electrode slurry easily occur due to the low content of crystalline Li₂Si₂O₅ or the low total content of the crystalline phase in the negative electrode active material, and as a result, the quality of the negative electrode deteriorates, and the charge/discharge capacity, initial efficiency and capacity retention rate are reduced because the negative electrode slurry becomes unstable.

What is claimed is:

1. A negative electrode active material, comprising:
particles comprising a silicon-containing oxide represented by SiOₓ, wherein 0<x<2; and
lithium distributed in the particles,
wherein the lithium is present in a form of (a) crystalline Li₂Si₂O₅, and optionally one or more selected from (b) crystalline Li₂SiO₃, (c) crystalline Li₄SiO₄ or (d) amorphous lithium silicate,
a content of the crystalline Li₂Si₂O₅ is higher than the sum of a content of the crystalline Li₂SiO₃ and a content of the crystalline Li₄SiO₄, and
a total content of the crystalline phase present in the particles is higher than a total content of the amorphous phase.

2. The negative electrode active material of claim 1,
wherein the lithium is present in the form of (a) crystalline Li₂Si₂O₅, (b) crystalline Li₂SiO₃, and optionally one or more selected from (c) crystalline Li₄SiO₄ or (d) amorphous lithium silicate.

3. The negative electrode active material of claim 1, wherein the total content of the crystalline phase present in the particles is more than 50 parts by weight and 80 parts by weight or less based on total 100 parts by weight of the particles.

4. The negative electrode active material of claim 1, wherein a difference between the content of the crystalline Li₂Si₂O₅ and the content of the crystalline Li₂SiO₃ is 1 part by weight to 40 parts by weight based on total 100 parts by weight of the particles.

5. The negative electrode active material of claim 1, wherein the negative electrode active material does not comprise the crystalline Li₄SiO₄.

6. The negative electrode active material of claim 1, wherein during ²⁹Si-MAS-NMR analysis of the negative electrode active material, a height of a peak p1 of Li₂SiO₃ that appears at a chemical shift peak of −70 ppm to −80 ppm is smaller than a height of a peak p2 of Li₂Si₂O₅ that appears at a chemical shift peak of −90 ppm to −100 ppm.

7. The negative electrode active material of claim 1, wherein during ²⁹Si-MAS-NMR analysis of the negative electrode active material, a ratio p2/p1 of a height of a peak p2 of Li₂Si₂O₅ that appears at a chemical shift peak of −90 ppm to −100 ppm to a height of a peak p1 of Li₂SiO₃ that appears at a chemical shift peak of −70 ppm to −80 ppm is more than 0.1 and 6.5 or less.

8. The negative electrode active material of claim 1, wherein a peak p3 of Li₄SiO₄ that appears at a chemical shift peak of −60 ppm to −69 ppm is not present during ²⁹Si-MAS-NMR analysis of the negative electrode active material.

9. The negative electrode active material of claim 1, wherein the negative electrode active material comprises the crystalline SiO₂ in an amount of less than 5 parts by weight based on total 100 parts by weight of the particles.

10. The negative electrode active material of claim 1, wherein the lithium is present in an amount of 0.5 part by weight to 25 parts by weight based on total 100 parts by weight of the negative electrode active material.

11. The negative electrode active material of claim 1, wherein a negative electrode active material obtained by adding 0.5 g of the negative electrode active material to 50 mL of distilled water and stirring the resulting mixture for 3 hours has a pH of 9 or more and 13 or less at 23° C.

12. The negative electrode active material of claim 1, further comprising a carbon layer disposed on the respective particles.

13. A method for preparing the negative electrode active material of claim 1, the method comprising:
preparing a composition for forming a negative electrode active material by mixing particles comprising a silicon-containing oxide represented by SiOₓ, wherein 0<x<2, with a lithium precursor; and
heat-treating the composition for forming the negative electrode active material at a temperature in a range of 780° C. to 900° C.

14. The method of claim 13, further comprising:
performing an acid treatment on the heat-treated composition for forming the negative electrode active material.

15. The method of claim 13, further comprising:
forming a carbon layer on the particles comprising the silicon-containing oxide before mixing the particles comprising the silicon-containing oxide with the lithium precursor.

16. The method of claim 13, wherein the heat treatment is performed for a time in a range of 1 hour to 12 hours.

17. The method of claim 13, wherein the heat treatment is performed in an inert atmosphere.

18. A negative electrode comprising:
a negative electrode current collector; and
a negative electrode active material layer disposed on at least one surface of the negative electrode current collector,
wherein the negative electrode active material layer comprises a negative electrode material comprising the negative electrode active material of claim 1.

19. A secondary battery comprising:
the negative electrode of claim 18;
a positive electrode facing the negative electrode;
a separator interposed between the negative electrode and the positive electrode; and
an electrolyte.
